(19) United States
(12) Patent Application Publication
(10) Pub. No.: US 2006/0128212 A1
(43) Pub. Date: Jun. 15, 2006

(54) Conductive mechanical bracket for mounting keystone jacks

(76) Inventor: Ronald A. Carrick, Pelham, NH (US)

Correspondence Address: Theodore Naccarella, Esquire;Synnestvedt & Lechner LLP, 2600 Aramark Tower, 1101 Market Street, Philadelphia, PA, 19107, US

(21) Appl. No.: 11/008,412

(22) Filed: Dec. 9, 2004

(51) Int. Cl. H01R 13/60

(52) U.S. Cl. 439/540.1

(57) ABSTRACT

A bracket for mounting keystone jacks in plates and panels. The bracket is formed of a conductive die-cast alloy consisting of mounting holes, a mounting window, and a catch mechanism. The bracket is structured to accept a keystone style interface while mounting the bracket to virtually any thickness plate or panel via the two mounting holes. The keystone style jack or insert is mechanically coupled to the bracket via the keystone latch and snaps securely into the bracket's catch mechanism. The conductive bracket provides secure mounting and reliable grounding.

### BACKGROUND OF THE INVENTION

1. Field of the Invention

This invention relates to the use of keystone jacks, such as Category (Cat) 5 and Cat 6 keystone jacks, in data communications networks connection assemblies, such as network panels and plates. More particularly, the invention pertains to methods and apparatus for mounting keystone style jacks to plates or panels.

2. Description of the Related Art

In a typical network, such as a Local Area Network (LAN), there is a need to connect cables to equipment or other cables through the use of mating plugs and jacks. One type of jack and plug connection commonly used in networks is the keystone type connection represented by, for instance, the RJ-45 style connectors that are commonly used for connecting telephones to wall outlets (i.e., wall jacks) and for connecting a telephone handset to the telephone base unit. However, keystone type jacks can be used in virtually any application. For instance, in a typical LAN for a small business, there will often be a wiring closet or other location in which one or more patch panels exists, each containing one or more keystone jacks. A keystone plug that terminates a cable connected to a piece of network equipment can be plugged into a jack in order to connect that piece of network equipment, e.g., a computer workstation, to the network or to other electronic equipment through the panel. The back side of the jack is coupled to the network or other equipment.

Referring to FIG. 1A, which is a pictorial of a typical rack panel assembly that might be found in a wiring closet, a metal frame 1 bearing one or more keystone jacks 2 is mounted in a standard wall box or in a wiring closet patch rack assembly 3. Cables with keystone plugs can be mounted to the jacks 2 in these frames 1 to attach the cable to the data communication network. The mounting frames 1 comprise multiple open cavities 4 in which multiple keystone jacks can be installed. Each keystone jack must be of a size and design suitable for mounting in the corresponding plate or panel.

Referring to FIG. 1B, which is a side view of an exemplary keystone jack 2 in the process of being mounted in a patch panel or plate 1, the keystone jack 2 is mounted to the plate or panel 1 using a flexible latch arm 5 extending from of the top side surface 2a of the jack 2. An extension 6 protrudes from the distal end of the arm 5. A rearward retaining ridge 7 extends from each vertical side surface 2b of the jack assembly and one or more forward retaining ridges 8 extending from the bottom side surface 2d of the jack 2 opposite the latch arm 5. The jack is inserted at an angle to the plane of the panel 1 with the forward retaining ridge 8 positioned against the front surface 9 of the panel 1. As the jack 2 is then tilted upwardly in the opening 4 of the panel 1, the extension 6 at the end of the flexible latch arm 5 encounters the edge of the opening 4 and the arm 5 flexes out of the way to permit the extension 6 to clear the edge. When the extension 6 clears the edge of the opening 4 (which occurs when the jack 2 is level or almost level), latch arm 5 snaps back to its neutral position, causing the surface 6a of the extension 6 to bear against the front surface 9 of the plate. Also as the jack becomes level relative to the panel, the rearward retaining ridges 7 lay flush against the back surface 10 of the panel 1. It should be understood by those skilled in the related arts that the forward edges of both of the rear retaining ridges 7 are the same distance from the front of the jack. Also, the rear surface 6a of the extension 6 on the latch arm 5 and the rear surface 8b of the forward retaining ridge 8 are the same distance from the front of the jack. The combination of the latch arm extension 6 and the forward retaining ridge 8 bearing against the front surface 9 of the panel 1, on the one hand, and the rearward retaining ridges 7 bearing against the rear surface 10 of the panel 1, on the other hand, secures the keystone jack 2 in the panel opening 4.

This mounting assembly has several drawbacks. First, the distal end of the latch arm 5 as well as the forward retaining ridge 8 extend from the front of the panel and, therefore, it can only be mounted in a plate or panel that is exactly the same thickness as the horizontal distance between the rearward retaining ridges 7, on the one hand, and the forward retaining ridge 8 and extension 6, on the other hand. They cannot be adapted to mount in a plate or panel of any thickness, but only a plate or panel having the proper thickness for these keystone connectors, e.g., 0.060 inches. However, sometimes it may be advantageous to mount both keystone jacks as well as other components on a thicker or thinner plate or patch panel.

### SUMMARY OF THE INVENTION

The invention pertains to a mechanical bracket of die-cast alloy suitable for mounting keystone jacks and inserts to network plates and panels. The mechanical bracket includes mounting holes, a mounting window and a catch mechanism that mechanically couples the bracket to a keystone style jack. The catch mechanism includes two mounting slots situated on the top and bottom side walls of the bracket's window, respectively. A keystone jack latch arm snaps in the catch mechanism when inserted into the bracket. After being snapped past the snap catch mechanism, the keystone jack is secured to the mounting bracket. Additional fastening clips are not needed and the conductive bracket mechanism can be mounted via the mounting holes to any thickness network plate or panel.

### BRIEF DESCRIPTION OF THE ACCOMPANYING DRAWINGS

FIG. 1 is a perspective view of a keystone jack mounting assembly in accordance with the prior art.

FIG. 2 is a perspective frontal view of a mechanical bracket in accordance with the present invention.

FIG. 3 is a perspective rear view of a mechanical bracket in accordance with the present invention.

FIG. 4 is a perspective blow-up view of a plurality of keystone jacks and brackets in accordance with the present invention being mounted to a patch panel.

FIG. 5 is a perspective view illustrating a plurality of keystone jacks mounted to a patch panel with brackets in accordance with the present invention.

FIG. 6 is a perspective view of a single keystone jack about to be mounted to a bracket in accordance with the present invention.

FIG. 7 is a frontal perspective view of a mounting bracket in accordance with the present invention in which a keystone jack is mounted in the bracket in accordance with the present invention.

FIG. 8 is a side view of a mounting bracket in accordance with the present invention in which a keystone jack is mounted in the bracket which, in turn is mounted to a patch panel.

FIG. 9 is a perspective view of a plurality of keystone jacks mounted to a plurality of brackets in accordance with the present invention which, in turn, are mounted to a patch panel.

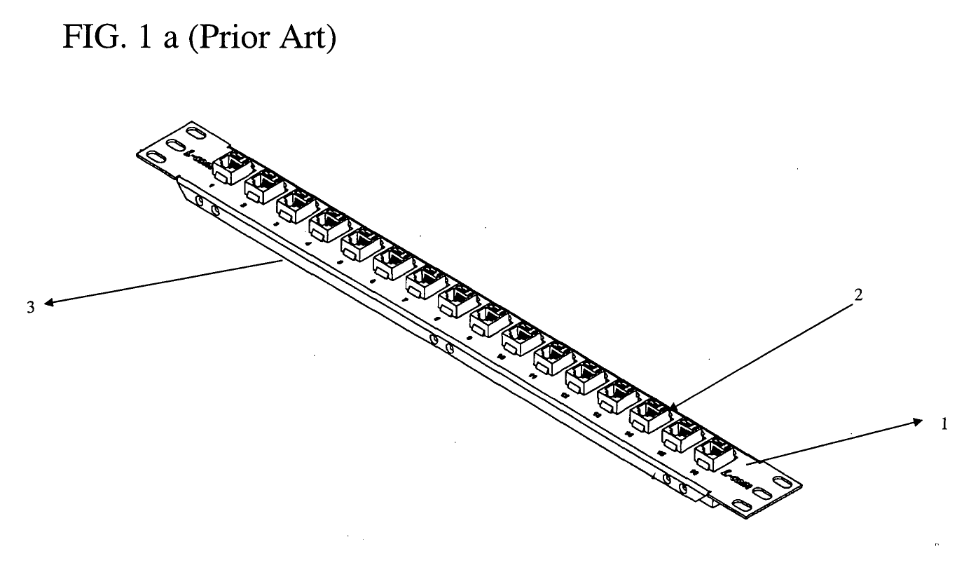

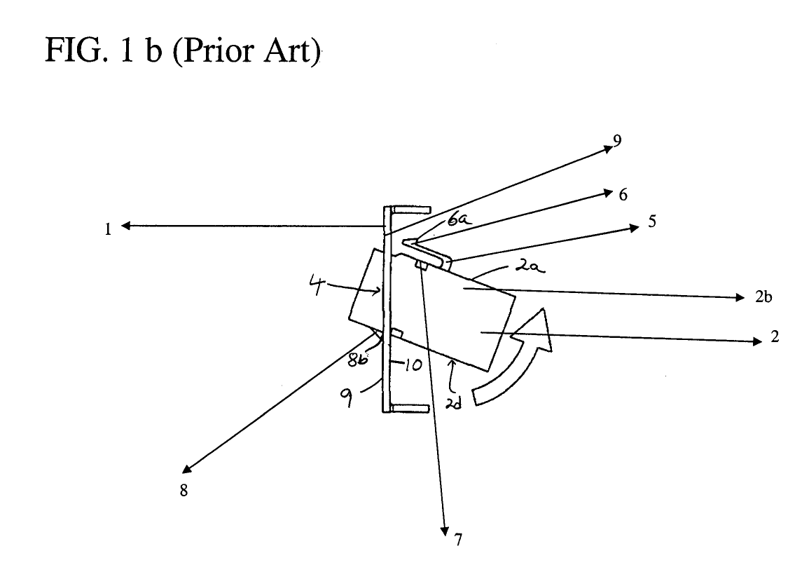

### DESCRIPTION OF A PREFERRED EMBODIMENT

Reference now will be made in detail to exemplary aspects of the present invention that are illustrated in the accompanying drawings. Wherever possible, the same reference numbers will be used throughout the drawings to refer to the same or like parts.

It is desirable to securely mount Cat 5, Cat 6 and other keystone jacks to network panels of any given panel or plate thickness and to protect the jacks and the patch panel from electromagnetic interference.

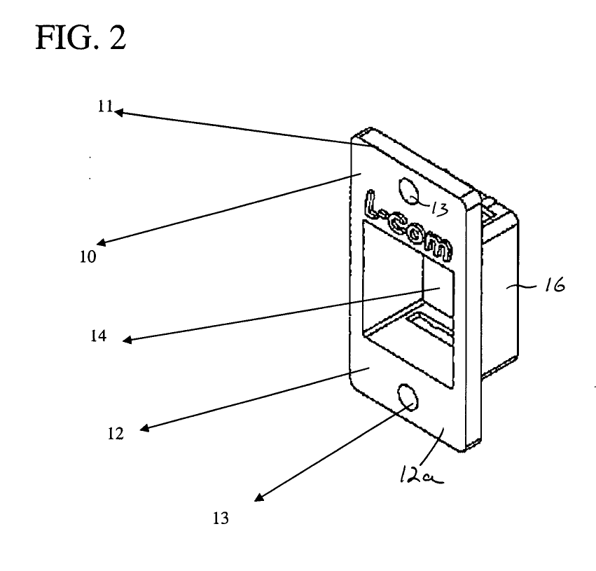

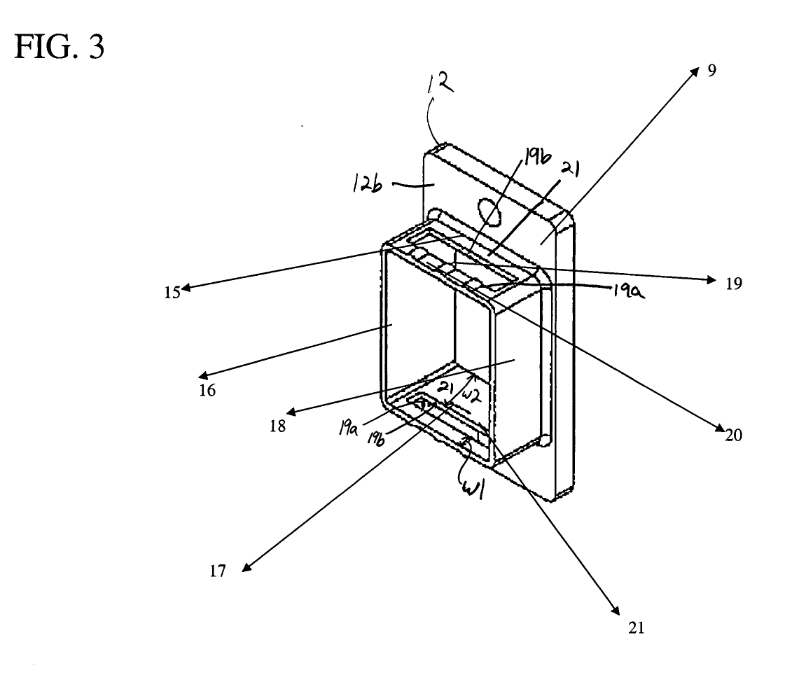

A mounting device assembly in accordance with the present invention is formed substantially according to FIGS. 2 and 3 of a mounting bracket 11 made of a conductive die-cast alloy. The mounting bracket 11 includes a mounting flange 12 provided with two mounting holes 13 that can be used to attaching the bracket to a patch panel by conventional securing means such as screws, rivets, nuts and bolts, or similar mechanisms. A mounting window 14 is disposed in the center of the mounting flange 12. The mounting window 14 is formed of a side wall preferably extending orthogonally rearwardly from the mounting flange 12 and includes four panels 15,16,17,18 generally forming a rectangle (when viewed in cross section taken parallel to the mounting flange 14). The top and bottom panels 15 and 17 include slots 19 that will be used as a catch mechanism for the jack. In a preferred embodiment of the invention, the slots 19 are identical. Each slot 19 defines an elongated strip 20 at the rear of panels 15 and 17 of the window 14 between the rear edge 19a of the slot 19 and the rear edge 15a, 17a of the panel 15,17. The slots 19 also define another elongated strip 21 at the front of the panels 15 and 17 between the front edge 19b of the slot 19 and the rear surface 12b of the mounting flange 12. Strips 20 have a width, w1, in FIG. 3, that is equal to the distance between the rearward retaining ridges 7, on the one hand, and the forward retaining ridge 8 and extension 6, on the other hand, of a keystone jack of the type that the bracket is adapted to be used in conjunction with. Width, w1, is the appropriate distance for a keystone jack, e.g., 0.060 inches.

Furthermore, the width, w2, of the second elongated strips 21 preferably are equal to each other and are selected so that the front of the jack that the bracket is adapted for use with, will be flush with the front surface 12a of the mounting flange 12. Optionally, the jack may be recessed or may protrude.

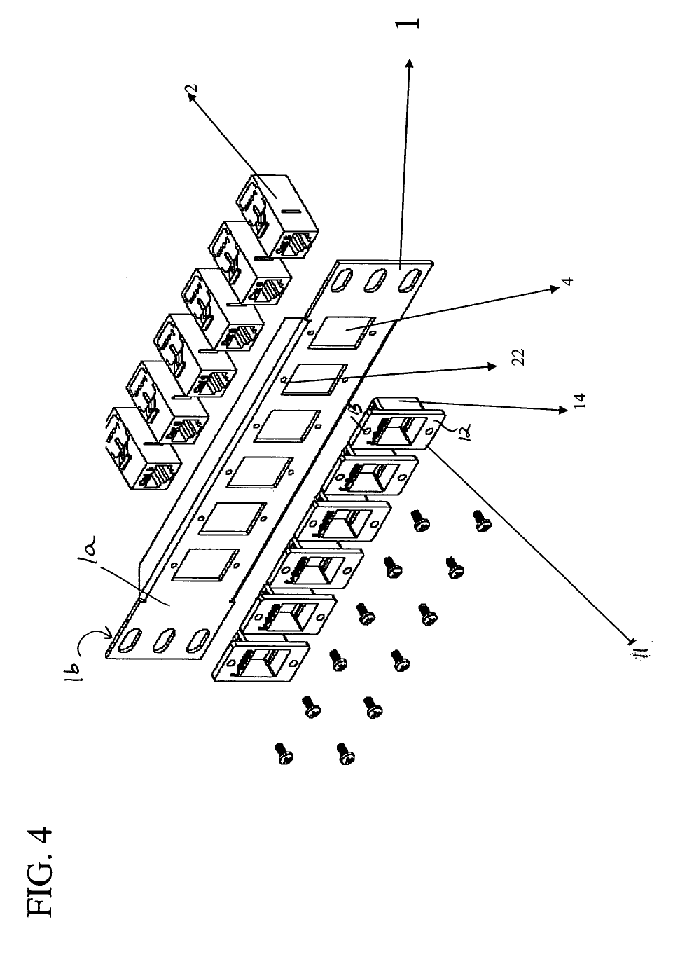

FIGS. 4, 5, 6, 7, 8, and 9 generally illustrate the mounting of a keystone jack 2 into a plate or panel 1 by using a mechanical bracket 11 in accordance with the present invention. In the description below, the bracket 11 is mounted to the panel before the jack is mounted to the bracket. This is merely exemplary and the order of the steps is not crucial. For instance, the jack can be mounted to the bracket before the bracket is mounted to the panel.

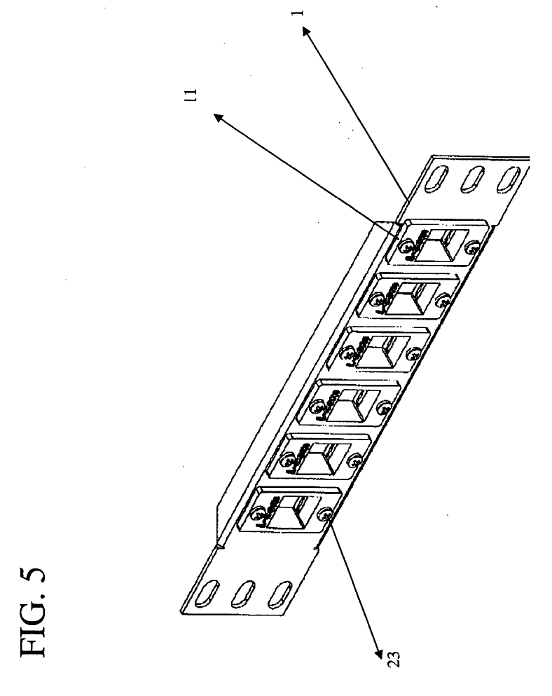

As best seen in FIG. 4, the brackets 11 are inserted into the apertures 4 of the panel 1. The mounting flange 12 of the bracket is larger than the aperture within which it is inserted such that the bracket does not pass through the aperture, but only the window 14 passes through. The rear surface 12b of the mounting flange 12 rests against the front surface 1a of the panel. Alternately, the bracket can be inserted from the back such that the front surface 12a of mounting flange 12 rests against the rear surface 1b of panel 1. In either event, the two holes 13 in the bracket are positioned so that they mate with two holes 22 in the panel above and below each aperture 4. Many standard patch panels do not have holes such as holes 22. In such cases, the holes can be drilled or otherwise placed in the panel in positions so as to mate with holes 13 of the bracket so that the bracket is positioned with the window 14 in line and centered within aperture 4 when the holes 13 in the bracket mate with the holes 22 in the panel. The mating holes 13 and 22 can be used to fixedly attach the bracket to the panel, such as by screws 23, bolts, rivets, etc. FIG. 5 shows the brackets 11 full, mounted to the panel 1.

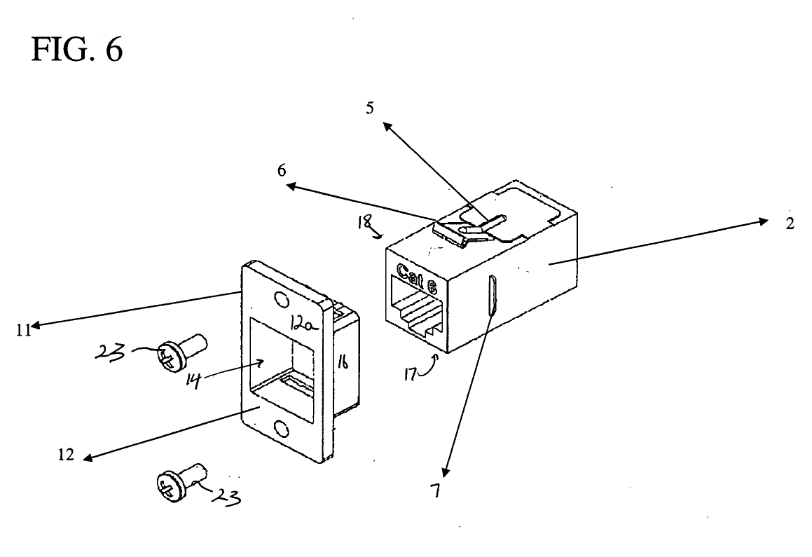

With reference to FIG. 6, 7 and 8, the jacks 2 can now be inserted into the brackets from the rear of the panel. In particular, the jack 2 is mounted to the bracket 11 by inserting the jack into the window 14 at an angle to the plane of the mounting flange 12 with the forward retaining ridge 8 positioned inside slot 19 in the bottom panel 17 of window 14. The jack 2 is then tilted upwardly in the window 14 until the extension 6 at the end of the flexible latch arm 5 encounters the strip 20 defined by the slot 19 in the top panel 15 of window 14. The arm 5 flexes out of the way to permit the extension 6 to clear the edge. When the extension 6 clears the strip 20 (which occurs when the jack 2 is level or almost level), the extension 6 clears the strip 20 and the latch arm 5 snaps back to its neutral position, causing the extension 6 to now be trapped within slot 19 in the top panel 15 of bracket. Also, as the jack becomes substantially level and the arm 5 snaps back to the neutral position, the rearward retaining ridges 7 of the jack become flush against the back edges 16a, 18a of side panels 16,18 of the window 14 of the bracket 11. The combination of the latch arm extension 6 and the forward retaining ridge 8 being trapped within the slots 19 and the rearward retaining ridges 8 bearing against the rear edges 16a, 18a of the side panels 16 of the bracket 11 secures the keystone jack 2 to the bracket.

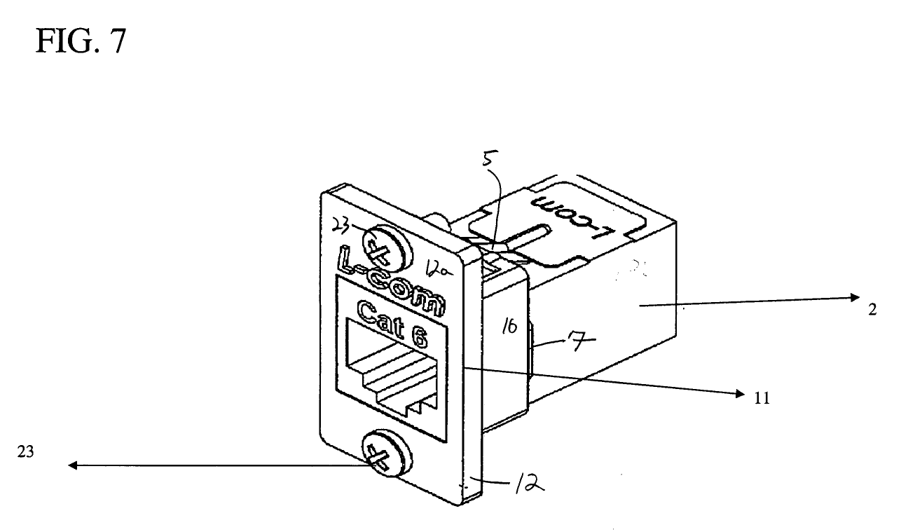

FIG. 7 shows a jack properly mounted to a bracket in accordance with the present invention. The screws 23 are shown for illustrative purposes even though the bracket is not shown mounted to a panel.

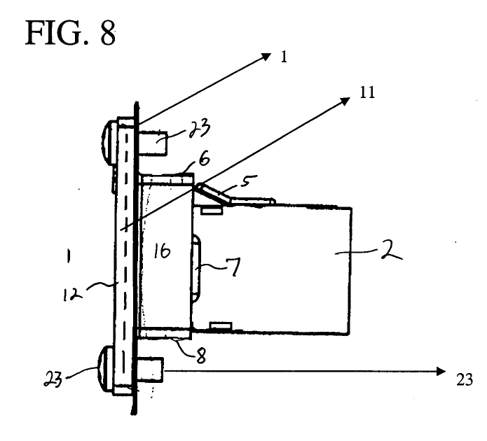

FIG. 8 shows a side view of a jack properly mounted to a bracket in accordance with the present invention and mounted within an aperture of a panel via two mounting screws.

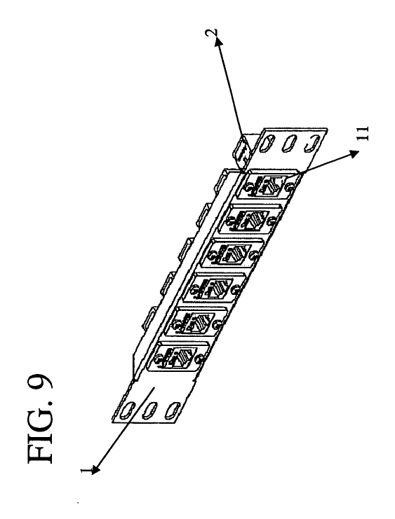

FIG. 9 shows a plurality of jacks mounted in a plurality of brackets which, in turn, are mounted to a patch panel 1. Note that each jack mounted in the single panel may be of a different type, e.g., Cat 5, Cat 6, as long as the jack is mounted in the appropriate mounting bracket. Thus jacks of different types can be mounted in the same patch panel. The thickness of the panel 1 is no longer of any significance. In fact, by use of the present invention, keystone jacks can be mounted in panels of any type, including panels that are not even made for use with keystone jacks. Also, the jack does not protrude from the panel where it can be damaged, but instead is flush with the panel or can even be recessed within the bracket in the panel.

Moreover, the present invention is also an important means of reducing electro-magnetic interference (EMI). EMI is electromagnetic radiation that is emitted by electrical circuits carrying rapidly changing signals as a by-product of their normal operation, and that causes unwanted signals (interference or noise) to be induced in other circuits. This interrupts, obstructs, or otherwise degrades or limits the effective performance of those other circuits. The mechanical bracket 11 in accordance with the present invention prevents EMI by virtue of its die-cast alloy construction, which provides a conductive ground path from the jack, through the bracket, to the panel (which presumably is grounded).

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. The foregoing description is by way of example only, and not limiting. The invention is limited only as defined in the following claims and equivalents thereto.

1. A bracket for mounting keystone jacks on a panel comprising:
a mounting flange;
at least one hole in said mounting flange, adapted to accept a securing means for securing said bracket to said panel;
a window in said mounting flange, said window comprising a side wall extending from said mounting flange, said window sized and shaped to accept a keystone jack therein; and
a slot in said side wall defining a strip between an edge of said slot and an edge of said side wall, said strip having a width equal to the distance between a rear retaining ridge and a forward retaining ridge of a keystone jack.

2. (canceled)

3. The bracket of claim 1 wherein said at least one hole comprises a first hole and a second hole disposed on opposing sides of said window.

4. The bracket of claim 3 wherein said securing means comprises a screw.

5. The bracket of claim 3 wherein said securing means comprises a bolt and nut.

6. The bracket of claim 1 wherein the slot comprises two slots on opposing sides of said window defining two of said strips.

7. The bracket of claim 6 wherein the two slots are positioned relative to each other and relative to a keystone jack to be mounted via said bracket so as to engage an extension of a latch arm of the jack and a forward retaining ridge of the jack, respectively.

8. The bracket of claim 1 wherein said side wall extends orthogonally from said mounting flange, completely surrounds said window, and has a rectangular cross-section parallel to said mounting flange.

9. The bracket of claim 1 wherein said strip is positioned relative to said mounting flange such that, when a keystone jack is mounted to said bracket, said keystone jack is flush with a front surface of said mounting flange.

10. The bracket of claim 1 wherein said bracket is conductive.

11. The bracket of claim 10 wherein said bracket is formed of a die-cast alloy.
